(19) United States
(12) Patent Application Publication
(10) Pub. No.: US 2023/0394449 A1
(43) Pub. Date: Dec. 7, 2023

(54) METHOD AND SYSTEM FOR TRANSFERRING FUNDS BETWEEN ACCOUNTS

(71) Applicant: AKCIONERNOE OBSHCHESTVO "NACIONAL'NAYA SISTEMA PLATEZHNYH KART, Moscow (RU)

(72) Inventors: Evgenij Georgievich SOLOV'EV, Moscow (RU); Dmitrij Aleksandrovich KOLESNIKOV, Moscow (RU); Natal'ya Olegovna PETUSHKOVA, Moscow (RU); Aleksej Alekseevich EZHKOV, Moscow (RU); Pavel Valentinovich RYABYJ, Moscow (RU); Evgeniya Mihajlovna BERLIZEVA, Moscow (RU)

(21) Appl. No.: 18/251,049

(22) PCT Filed: Oct. 28, 2021
(86) PCT No.: PCT/RU2021/000469

§ 371 Date: Apr. 28, 2023

(30) Foreign Application Priority Data
Nov. 11, 2020 (RU) 2020136985

(51) Int. Cl. G06Q 20/10

(52) U.S. Cl. CPC G06Q 20/10

(57) ABSTRACT

The suggested technical solution pertains to the financial industry, i.e. To processing of electronic off-us funds transfers from one account to another. The advantages of the presented system and method are the acceleration of off-us funds transfers from one account to another for all scenarios of funds transfers processing, in which the recipient of the funds transfer is the initiator, including the automatic recurrent funds transfers; a high reliability and high liquidity are also achieved during implementation of this invention. The system includes devices and banks of the Payer and the Recipient, the Database, the Payment Order ID Generation Module, the Processor for payment order ID detection and marking of a payment order, the Settlement System for making settlements between the Payers bank and the Recipients bank. The automated method comprises the steps during which a part of the payment order data is generated by the Recipients device and sent to the Processor, where the payment order ID is received from the Payment Order ID Generation Module, bound to the payment order data part and sent to the Recipients device. The Recipient's device sequentially transfers the data to the Payers device, to the Payers bank, and to the Processor. The Processor detects the payment order ID, receives the missing part of the payment order data from the Recipients bank and generates the final payment order; then this order is marked for settlements when making a payment and sent to the Settlement System. Then, the Settlement System sends a response about the off-us funds transfer performance. The Processor sends the specified response to the Payers bank and the Recipients bank, and receives (in response) messages from the Payers bank and the Recipients bank with confirmation of debiting funds from the Payers account and crediting funds to the Recipients account, respectively.

The suggested technical solution pertains to the financial industry, i.e. to electronic off-us funds transfers from one account to another.

Currently, there are various methods for on-us and off-us funds transfers from one account to another. At the same time, various scenarios for sending and receiving funds transfers are implemented: funds transfers by an individual between their accounts (me2me); funds transfers between individuals (c2c), transfers from an individual to a legal entity and vice versa (c2b, b2c), transfers between legal entities (b2b), transfers from government institutions to accounts of individuals and vice versa (g2c, c2g), funds transfers from government institutions to accounts of legal entities and vice versa (g2b, b2g), funds transfers within one state or between countries (g2g). Moreover, there are various scenarios of funds transfers: automatic recurring payments, such as payments for subscriptions, payroll, financial aid, and so on.

For the scenarios listed above, there are two mechanisms for transferring funds: the transfer is initiated by the sender of funds (x2x push) or the transfer is initiated by the recipient of funds (x2x pull).

For every existing funds transfer scenario, including automatic recurring payments, there is a need for a fast and reliable method for off-us transfer of funds from one account to another. The invention suggested in the application makes it possible to automatically accelerate funds transfers and maintain their reliability for all scenarios in which the transfer is initiated by the recipient of funds (x2x pull).

Currently, for all the specified scenarios, there are various methods for funds transfers. Since off-us transfers performance in known methods happens once in a certain period of time, there is a need to accelerate funds transfers and maintain high reliability of funds transfers, as well as to expand the scope of implementation of the described system and method, taking into account all possible scenarios of off-us funds transfers from one account to another in which the recipient of funds initiates the transfer.

An invention known in the art describes a system and methods for managing a payment system comprising a payer interface for communication between the processor and the payer, a transaction ID generation module, a recipient interface configured to confirm that information about the payment transaction is accurate, initiating the transfer of funds by the processor to funds recipients.

As a result, performance of an electronic payment transaction is ensured (RF patent No. 2628326, G06Q20/10, dd.15.08.2017).

The drawback of the invention is the need for the payer to enter the payment amount, the recipients account ID and ID of the product or service and then send this information to the processor to generate a transaction ID; therefore, in the described system, it is impossible to automate the transfer of funds, in which the initiator of the transfer is the recipient of funds. Moreover, the invention does not involve the fulfillment of monetary obligations directly when making a payment according to all known funds transfer scenarios.

The closest analogous solution to the patentable invention is the system and method used for settlement for payment transactions (USA patent application No. 2018308070, G06F17/30; G06Q20/02, dd. 24.10.2018), which include the Recipients bank and the Payers bank, the Processor and the Settlement System, within which a message is sent from the Payers bank to the Processor to initiate a payment transaction, and then the message is sent to the Recipients bank, where the specified message is checked and then a confirmation of the payment transaction is sent to the Processor. The Processor checks the presence of a marker in the message; then the message is transferred to the Settlement System which generates an order to transfer funds between the accounts of the Payer and the Recipient; after that, a notification of the transaction performance is transferred from the Settlement System to the Processor; and finally, settlements for the transaction between the accounts of the Payers bank and Recipients bank are made.

As a result of the technical solution use, when initiating a transaction through the Processor, settlements on network transactions are performed by the Settlement System by the order of the devices initiating the transaction.

The drawback of the described technical solution is the low speed of the off-us funds transfer, because, before sending a message to the Settlement System, it is required to generate a file of net positions; this significantly slows down the processing of the funds transfer; therefore, the system and method do not ensure the online transfer of funds between banks for every separate transaction; the speed is also affected by the need to convert the first message format to the second message format during the transaction before generating the order to transfer funds, and then convert the second message format to the first message format before sending the payment notification; this increases the time of off-us funds transfers from one account to another.

The technical problem to be solved by this invention is the creation of an automated system and method for off-us funds transfers from one account to another, in which off-us transfers initiated by the recipient of funds are accelerated for all possible scenarios of funds transfers (where both the payer and the recipient may act as an individual, a legal entity or the state), including those with automatic recurring transfers of funds.

The technical result achieved by the implementation of this invention is acceleration of the automated system and the method of off-us funds transfers from one account to another for all scenarios of processing funds transfers in which the initiator of the funds transfer is the recipient including automatic recurring funds transfers, by including in the system and method the stages of generating a payment order ID, recognizing the payment order ID, marking the final payment order based on the presence of the payment order ID, sending a marked final payment order to the Settlement System for settlements between the Payer and the Recipient for each separate transaction upon receipt of an order to transfer funds under any existing funds transfer scenario; also, when implementing this invention, a high speed of off-us funds transfers from one account to another is achieved because the system and the method provide for the generation of a payment order ID in the Module for generating a payment order ID, marking the final payment order based on the presence of the payment order ID in the Processor and making settlements between the Payer and Recipient upon receipt of the marked final payment order and an order to transfer funds in the Settlement System, which ensure recognition of the payment and settlements between the Payer and the Recipient immediately upon receipt of the order to transfer funds; the high speed of funds transfers from one account to another is ensured alongside with high reliability due to the exchange between banks of the payment order for its approval when making the funds transfer; this approach eliminates the possibility of refusal during settlement transactions; the system and method also provide high liquidity since the transfer of funds is performed not once in a certain period of time, but directly in the process of funds transferring for each separate transaction; as a result, the Recipient's bank immediately receives funds from the Payers bank and credits them to the Recipients account.

The specified technical result is achieved in the system for off-us funds transfers from one account to another; this system comprises the Payers device and the Recipient's device, the Payers bank and the Recipient's bank, the Database, the Module for generating the payment order ID, the Processor configured to recognize the payment order ID and marking payment orders, the Settlement System configured to make settlements between the Payers bank and the Recipient's bank upon the receipt of the marked payment order from the Processor.

In particular, the Database is configured to receive, record, store and search for the payment order ID bound to the payment order details.

In particular, the Recipient's device is configured to transfer to the Payers device a part of the payment order data in a machine-readable format containing the payment order ID.

In particular, the Payers device is configured to at least partially capture a part of the payment order data containing the payment order ID received from the Receivers device.

In particular, the Payers bank, the Processor and the Recipient's bank are configured to perform checks and complete the payment order.

In particular, the Processor is configured to interact with the ID Generation Module, the Database, the Payers and Recipient's banks, and the Settlement System.

The specified technical result is also achieved in an automated way to perform the off-us funds transfer from one account to another, where:
on the device of the Recipient, a part of the payment order data is generated and then a part of the payment order data is sent to the Processor;
the Processor receives a part of the payment order data, then it receives the payment order ID from the Payment Order ID Generation Module, then the payment order ID is bound to a part of the payment order data and the part of the payment order data containing the payment order ID is sent to the Recipient's device;
after that, the specified part of the data is transferred from the Recipient's device to the Payers device;
the Payers device receives the specified part of the data, this part is then transferred to the Payers bank, and then it is transferred from the Payers bank to the Processor;
the Processor receives the specified part of the data, recognizes the payment order ID, and then transfers the specified part of the data to the Recipient's bank;
the Recipient's bank receives the specified part of the data containing the payment order ID, then it is supplemented with the missing part of the payment order data; after that, both parts of the payment order data including the payment order ID are sent to the Processor;
the Processor receives these both parts of the payment order data, generates the final payment order, then marks the final payment order for settlements when making a payment and then sends the final payment order to the Settlement System; after that, a response from the Settlement System concerning the funds transfer performance between banks is received;
the Processor sends the specified response concerning the funds transfer performance to the Payers bank and the Recipient's bank;
in response, the Processor receives a message from the Payers bank and a message from the Recipient's bank confirming that funds have been debited from the Payers account and credited to the Recipient's account, respectively.

In particular, a part of the payment order data containing the payment order ID in a machine-readable format is transferred from the Recipient's device to the Payers device.

In particular, the Payers device (at least partially) captures a part of the payment order data containing the payment order ID received from the Recipient's device.

In particular, the Payers bank, the Processor and the Recipient's bank check and supplement the data of the payment order.

In particular, the Recipients bank receives a part of the payment order data from the Processor containing the payment order ID, checks and sends a confirmation of the readiness to credit funds to the Processor.

In particular, the Payers bank checks a part of the payment order data containing the payment order ID before transferring the specified part of the data to the Processor and sends a confirmation of the readiness to debit funds to the Processor.

In particular, the ID Generation Module generates a payment order ID, then the payment order ID is sent to the Processor, and then to the Database.

In particular, the Processor accesses the Database and stores the payment order ID bound to the part of the payment order data.

In particular, the Processor accesses the Database and receives the payment order ID from the Database.

In particular, the results of the system elements communication are sent to the Database from the Processor; there these results are stored.

In particular, the final payment order is generated in the Recipient's bank and then transferred to the Processor.

In particular, the Settlement System determines the presence of a marker for settlements in the final payment order when making a payment and then makes settlements between the Payers bank and the Recipient's bank.

A part of the payment order data, as used herein, is the information that can be sent and/or received by various technical devices using various techniques via a computer network. A part of the payment order data is used to transfer funds (and/or initiate a transfer) from the account of the sender of funds to the account of the recipient of funds. Examples of methods for a part of the payment order data transfer include but are not limited to a link, numeric and alphabetic characters, QR code, barcode, NFC, Bluetooth and/or BLE, etc.

Payers device is an electronic programmed device configured to receive a part of the payment order data comprising the payment order ID, to initiate a funds transfer from the Payers account to the Recipient's account by sending to the Payers bank data sufficient to initiate the funds transfer from the Payers account. For example, the Payers device can be a smartphone, computer, etc.

Recipient's device is a device configured to generate a part of the payment order data and send to the Recipient's bank a specified part of the data necessary to make a funds transfer between accounts. According to one invention embodiment, the Recipient's device may be configured to display the specified part of data in a machine-readable format for capturing of the specified part of data by the Recipient's device.

The Processor, as used herein, is at least one computing device configured to interact with the Database, the Payment Order ID Generation Module, the Payers bank system, the Recipient's bank system, and the Settlement System. Thus, the Processor acts as the control center of the system, configured to ensure the exchange of messages with all system elements. The Processor sends the results of the system elements communication to the Database for their storage.

The Processor is configured to receive a part of the payment order data from the Recipient's bank, process the received data, and send the processed data to the Recipient's device via the Recipients bank. The processing of the received data includes requesting the payment order ID in the ID Generation Module, complementing of a part of the payment order data with the payment order ID, and sending a part of the payment order data bound to the payment order ID to the Recipients bank and the Database.

The Processor is configured to receive data from the Payers bank, including a part of the payment order data containing the payment order ID and a confirmation of readiness to debit funds. Also, the Processor is configured to recognize the payment order ID and complement the part of the payment order data. The latter means that the Processor exchanges messages with the Database, receives payment order data from the Database, such as, for example, the Processor ID, message ID, and others, after which the Processor complements the part of the payment order data containing the payment order ID.

The Processor receives data from the Recipients bank, including both parts of the payment order data containing the payment order ID and confirmation of the Payers bank's readiness to credit funds. The Processor is configured to generate the final payment order based on the payment order data. Based on the presence of the payment order ID in the message, the Processor marks the generated final payment order for online settlements, that is, settlements between banks at the time of the payment. The Processor is configured to send a marked generated final payment order to the Settlement System with a request to transfer funds from the Payers account to the Recipients account immediately when making the payment. Marking the final payment order by the Processor prior to sending it to the Settlement System accelerates off-us funds transfers from one account to another and simultaneously expands the scope of application, as it allows the Settlement System to determine the need to process data immediately upon receipt of the final payment order and in accordance with any type of the funds transfer scenario.

Also, the Processor is configured to receive a message from the Settlement System, including a message containing a confirmation of the funds transfer performance. Based on the message received from the Settlement System, the Processor generates messages for the Payers bank and the Recipient's bank; after that, the Processor simultaneously sends a message to the Payers bank and a message to the Recipients bank containing a command to debit funds from the Payers account and credit these funds to the Recipients account, respectively. The Processor receives a response from the Payers bank containing a confirmation of funds debiting from the Payers account and a message from the Recipient's bank containing a confirmation of funds crediting to the Recipient's account. Thus, when the Recipient is the initiator, the funds transfer is performed according to all existing funds transfer scenarios and right at the time of payment, does not require additional steps, such as generation of a file of net positions or correction/modification of various message formats.

The Database is a device programmed to receive, record, store and search for the payment order ID, the results of the system elements communication and the details of the payment order, including, but not limited to: the Payers ID and/or the Recipients ID and/or the Bank's ID and the account number at the bank related to the payment order ID. The Database may be autonomous or be part of at least one of the system components for the performance of off-us funds transfers from one account to another.

The Payment Order ID Generation Module is a device programmed to generate a payment order ID used for the funds transfer between two or more bank accounts. The Payment Order ID Generation Module can be autonomous or be part of at least one system component for funds transfer performance from one account to another. The Payment Order ID Generation Module is configured to interact with the Processor, i.e. to receive a message with a request for a payment order ID, generate a payment order ID and send it in response to the Processors request.

The Settlement System, as used herein, is a software and hardware complex containing at least one computing device programmed to transfer funds between bank accounts upon receipt of a request from the Processor to transfer funds from account to account and change the values of the funds amounts on settlement accounts.

Below, the invention is explained in drawings.

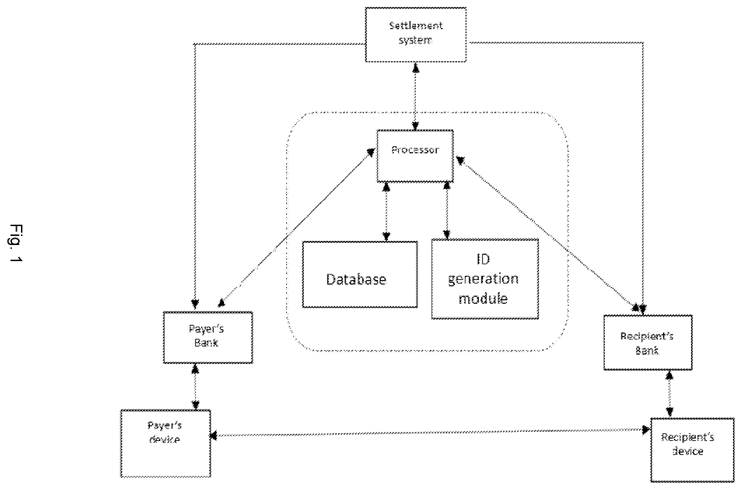

FIG. 1—system for funds transfer from one account to another.

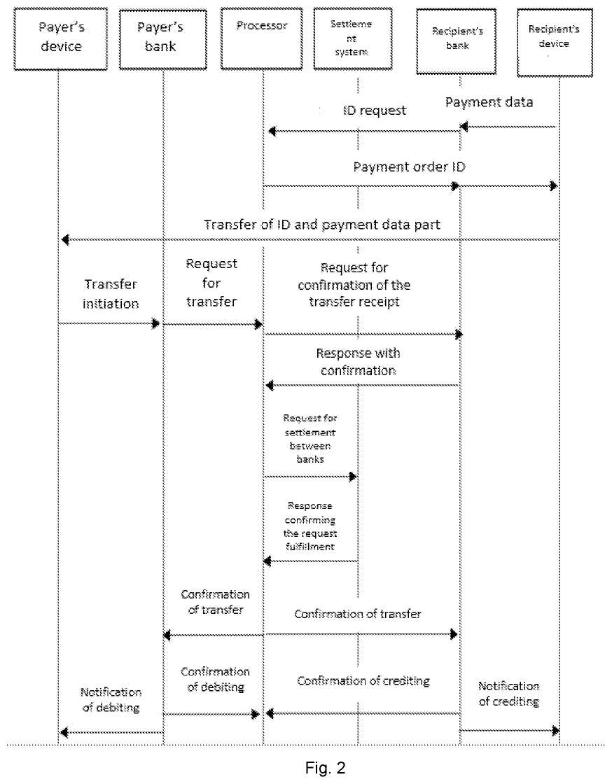

FIG. 2—method for funds transfer from one account to another.

Detailed description of the implementation of the claimed automatic technical solution.

At the first stage, a part of the payment order data is generated by the Recipients device; this data serves as the basis for subsequent generation of the payment order ID and includes the Recipients data and payment data. After that, the generated part of the payment order data is sent to the Recipients bank, and then to the Processor. According to one invention embodiment, a part of the payment order data may also contain the Payers data, however, this option is not a prerequisite for the method and achievement of a technical result.

The Processor receives a part of the payment order data and on the basis of this data determines the need to generate the ID; after that, it sends a request to the Payment Order ID Generation Module, receives a response containing the payment order ID, then binds the payment order ID with a part of the payment order data and sends a part of the payment order data containing the payment order ID to the Database and to the Recipients device through the Recipients bank.

After that, the Recipients device transfers the specified part of data containing the payment order ID in any machine-readable format to the Payers device. The Payers device receives a part of the payment order data containing the payment order ID. The specified part of data is received by the Payers device in various ways, for example, by partial capture of the specified part of the data, by following the link containing the specified part of the data, etc. The specified part of the data may contain, including, but not limited to: payment order ID, Recipients data or ID, Recipients bank or bank ID, Payers data or ID, Payer's bank or bank ID, the amount of funds transfer, and other payment data.

Further, the specified part of data is received from the Payers device, the transfer is confirmed and sent to the Payers bank; after that, the specified part of data is received in the Payers bank, the availability of confirmation for the funds transfer is determined, and then the specified part of data and the confirmation of the funds transfer are sent to the Processor.

According to one invention embodiment, before the receipt of the confirmation from the Payers device, a request for information related to the payment order ID is sent to the Processor through the Payers bank. Then, in response, the payment order data extracted from the Database are received from the Processor and then displayed on the Payers device. This stage is required to improve the reliability of the described system and method, since it reduces the likelihood of errors.

The Processor receives a part of the payment order data containing the payment order ID, recognizes the payment order ID with the use of which the specified part of the data is determined as a request for the funds transfer for one transaction and right at the time of the payment. After that, the Processor sends a request to the Database to receive information on the payment order ID, receives a response with the data bound to the payment order ID.

Then the Processor sends a part of the payment order data containing the payment order ID to the Recipients bank. The Recipients bank checks the specified part of the data and confirms the readiness to credit the funds to the Recipients account; after that the said part of the data is complemented with the missing part of the payment order data, sufficient for the off-us funds transfer. After that, a message containing at least a confirmation of readiness to credit funds to the Payers account and both parts of the payment order is sent from the Recipients bank to the Processor. The confirmation step is necessary for transactions of the type described in this application and additionally increases the reliability of the system and method, since it eliminates the errors occurrence and, as a result, transaction failures. According to one invention embodiment, the Recipients bank processes both parts of the payment order, generates the final payment order, and then sends it to the Processor.

The Processor receives the specified message from the Recipients bank, complements the received data and generates the final payment order; after that, the order is marked for the transactions performance directly upon receipt in the Settlement System. According to one invention embodiment, the Processor receives the generated final payment order from the Recipients bank; after that this order is marked for the transactions performance directly upon receipt in the Settlement System.

After that, the marked generated final payment order is sent to the Settlement System. There, the request for settlements when making a payment is determined by the marker and funds are debited from the Payers bank account and credited to the Recipients bank account in accordance with the data of the marked generated final payment order. Then the Settlement System sends a response to the Processor about the funds transfer performance. According to one invention embodiment, the response about the funds transfer performance is sent to the Processor after processing the marked generated final payment order, and then settlements are made between the accounts of the Payers bank and the Recipients bank.

After receiving a response from the Settlement System, the Processor simultaneously sends notifications about the funds transfer performance: a request to debit funds from the Payers account is sent to the Payers bank and a request to credit funds to the Recipients account is sent to the Recipients bank.

The method described above can be carried out using the automated system described in the application for off-us funds transfers from one account to another.

The advantages of the presented system and method are the acceleration of off-us funds transfers from one account to another for all scenarios of funds transfers processing, in which the recipient of the funds transfer is the initiator, including the automatic recurrent funds transfers; a high reliability and high liquidity are also achieved during implementation of this invention.

1. The system for electronic transactions processing for the off-us funds transfers performance from one account to a different account, the system comprising:
a recipient's device configured to,
generate a first part of payment order data, which is required for funds transfers between accounts, wherein the first part comprises recipient's data and payment data, and
send the first part to a processor through a recipient's bank;
the recipient's bank configured to,
receive a payment order identification and the first part of the payment order data,
complement the first part with the second part of the payment order data, which is sufficient for the off-us funds transfer performance and submission of the payment order data to the processor;
a sender's device configured to receive the payment order identification and the first part of the payment order data from the recipient's device;
a sender's bank configured to,
receive the payment order identification and the first part of the payment order data from the sender's device; and
transfer the payment order identification and the first part of the payment order data to the processor;
the payment order identification generation module configured to,
receive the first part of the payment order data from the processor, based on the part of the payment order identification generation; and
send the generated payment order identification to the recipient's bank and the recipient's device;
the processor configured to,
receive the payment order identification and the first part of the payment order data and the second part of the payment order data, generate the final payment order;
mark the final payment order with a marker indicating that the funds have to be transferred after the receipt of the final payment order; and
send the final payment order to a settlement system; and
the settlement system configured to,
receive the final payment order;
detect the marker in the final payment order, and
in response to detection of the marker in the final payment order, transfer funds from the payer's account to the recipient's account for each separate transaction.

2. The system according to claim 1, comprising a database configured to receive, record, store and search for the payment order identification based on the first part and the second party of the payment order data.

3. The system according to claim 1, wherein the recipient's device is configured to transfer to the sender's device at least a part of the payment order data in a machine-readable format that includes the payment order identification.

4. The system according to claim 1, wherein the sender's device is configured to at least partially capture a part of the payment order data that includes the payment order identification received from the recipient's device.

5. The system according to claim 1, wherein the sender's bank, the processor and the recipient's bank are configured to perform checks and complete the final payment order.

6. The system according to claim 1, wherein the processor is configured to interact with the payment order identification generation module, the sender's bank, the recipient's bank, and the settlement system.

7. The automated method for electronic transactions processing for the off-us funds transfers performance from one account to different account, wherein the automated method comprises:
generating, by a recipient's device, a part of a payment order data required for funds transfers performance between accounts, wherein the payment order data comprises recipient's data and payment data;
sending the part of the payment order data to a processor with the help of which, based on the received data, the need to generate an ID is determined and a request is sent to the payment order ID generation module;
generating a payment order identification based on payment order data;
receiving, by the processor, the payment order identification that is bound to the payment order data, wherein the payment order data and the payment order identification are stored in a database;
sending a part of the payment order data that includes the payment order identification to a recipient's device;
submitting, by the recipient's device, the part of the payment order data that includes the payment order identification to a payer's device;
receiving, by the payer's device receives the part of the payment order data that includes the payment order identification;
transferring, by the payer's device, the part of the payment order data that includes the payment order identification to a payer's bank;
receiving, by the payer's bank, the part of the payment order data that includes the payment order identification;
sending, by the payer's bank, the part of the payment order data that includes the payment order identification to the processor;
receiving, by the processor, the part of the payment order data that includes the payment order identification;
detecting, by the processor, the payment order identification;
checking, by the processor, whether the payment order identification is stored in the database;
submitting, by the processor, the part of the payment order data that includes the payment order identification to a recipient's bank;
receiving, by the recipient's bank, the part of the payment order data that includes the payment order identification,
complementing, by the recipient's bank, a missing part of the payment order data, which is sufficient for the off-us funds transfer performance, to create a completed payment order data;
sending, to the processor, the completed payment order data, including the payment order identification;
receiving, by the processor, the completed payment order data;
generating, by the processor, a final payment order based on the completed payment order data;
marking, by the processor, with a marker the final payment order for settlements after making a payment; wherein the marker is indicative of a need to transfer funds after receiving such the final payment order;
sending the final payment order to a settlement system;
receiving,
by the settlement system, the final payment order;
determining, by the settlement system, the presence of the marker in the final payment order;
in response to determining the presence of the marker, transferring funds from a sender's account to recipient's account for each separate transaction;
receiving, by the processor, a response from the settlement system about the off-us funds transfer performance;
sending, by the processor, the response about the off-us funds transfer performance to the payer's bank and the recipient's bank; and
in response to sending the response, receiving by the processor a message from the payer's bank and a message from the recipient's bank confirming that funds have been debited from the payer's account and credited to the recipient's account, respectively.

8. The automated method according to claim 7, comprising transferring by the recipient's device a part of the payment order data in a machine-readable format that includes the payment order identification to the payer's device.

9. The automated method according to claim 7, comprising capturing, by the payer's device, at least a portion of a part of the payment order data that includes the payment order identification received from the recipient's device.

10. The automated method according to claim 7, comprising checking and supplementing the final payment order.

11. The automated method according to claim 7, comprising:
receiving, by the recipient's bank, a part of the final payment order from the processor that includes the payment order identification;
checking the part of the finally payment order that includes the payment order identification; and
sending a confirmation of a readiness to credit funds to the processor.

12. The automated method according to claim 7, the automated method differing in that the Payer's bank checks a part of the payment order data containing the payment order ID before transferring the specified part of the data to the Processor and sends a confirmation of the readiness to debit funds to the Processor.

13. The automated method according to claim 7, the automated method differing in that the Payment Order ID Generation Module generates a payment order ID, then the payment order ID is sent to the Processor, and then to the Database.

14. The automated method according to claim 7, the automated method differing in that the Processor accesses the Database and stores the payment order ID bound to the part of the payment order data.

15. The automated method according to claim 7, the automated method differing in that the Processor accesses the Database and receives the payment order ID from the Database.

16. The automated method according to claim 7, the automated method differing in that the results of the system elements communication are sent to the Database from the Processor. There these results are store.

17. The automated method according to claim 7, the automated method differing in that the final payment order is generated in the Recipient's bank and then transferred to the Processor.

18. The automated method according to claim 7, the automated method differing in that the Settlement System determines the presence of a marker for settlements in the final payment order when making a payment and then makes settlements between the Payer's bank and the Recipient's bank.
